(19) United States
(12) Patent Application Publication
(10) Pub. No.: US 2015/0294686 A1
(43) Pub. Date: Oct. 15, 2015

(54) TECHNIQUE FOR GATHERING AND COMBINING DIGITAL IMAGES FROM MULTIPLE SOURCES AS VIDEO

(71) Applicant: YouLapse Oy, Helsinki (FI)

(72) Inventor: Antti AUTIONIEMI, Helsinki (FI)

(73) Assignee: YouLapse Oy, Helsinki (FI)

(21) Appl. No.: 14/250,520

(22) Filed: Apr. 11, 2014

(51) Int. Cl. G11B 27/036; H04N 5/262; H04N 5/222

(52) U.S. Cl. CPC G11B 27/036; H04N 5/2224; H04N 5/262

(57) ABSTRACT

Electronic arrangement, optionally a number of servers, including: a computing entity configured to receive image entities from a plurality of electronic devices, optionally mobile terminals, and configured to process the image entities, the computing entity being specifically configured to: obtain a plurality of image entities from the plurality of electronic devices, and combine the obtained image entities into a video representation according to the metadata associated with the image entities, optionally date and/or time data, and/or the source of the image entities. A corresponding method is also presented.

### FIELD OF THE INVENTION

Generally the present invention concerns gathering digital content from various sources and creating a video of the gathered content. Particularly, however not exclusively, the invention pertains to a method for creating a video representation of images gathered from various users and devices.

### BACKGROUND

Recently the development of smartphone cameras and digital cameras has led to an increasing popularity in creating graphical digital content. The ability to carry a digital camera to virtually anywhere allows users to more freely express their creativity and take a lot of pictures and videos of anything ranging from vast gatherings such as festivals to ordinary everyday life situations such as seasonal changes in nature.

Nowadays, people also tend to be very collective in sharing and using content and being part of a jointly created content is often felt as a part of identity and emotional attachment. However, going through a massive selection of unsorted photos, images, videos and even audio from different dates, locations and devices is arduous and inefficient. Hence, in the absence of a better use a large part of user created content is often forgotten and left unused and unorganized in storage folders and such, particularly since so much content is produced and managing the content with reverence is needlessly time-consuming for users.

Collecting idle and unused, or any, content from a plurality of users is possible with today's systems but it is often arranged so that the users still have to proactively choose and pick the content they wish to share with a system such as a blogging platform, social media or an image sharing or saving system. Moreover, these systems aren't able to take advantage, arrange and merge multimedia content in a way other than how the users manually arrange, categorize and wish to present the content. Again evidently, individual users are left with all the managing and sharing of their content, and even then, they aren't able to create and merge content easily with other users, who would possess similar content, but with whom they aren't in touch with. For example, users who have attended and created content of a happening, such as people attending a festival who take photos and video, aren't usually in touch with each other and are so unable to crate content together, and for this reason end up just storing content or at best using some content for their own purposes, such as posting a number of photos on a social media system.

Hence, obviously creating more cohesive and meaningful content from a plurality of user created multimedia content from various users has been poorly solved, if at all.

### SUMMARY OF THE INVENTION

The objective of the embodiment of the present invention is to at least alleviate one or more of the aforesaid drawbacks evident in the prior art arrangements particularly in the context of utilizing various image sources to create video content. The objective is generally achieved with an arrangement and a method in accordance with the present invention by having an arrangement capable of connecting to a plurality of electronic devices comprising image entities and a method to collect said image entities and combine them into a video representation.

One advantageous features of the present invention is that it allows for collecting content, such as pictures, photographs and other image files from a plurality of devices and to combine such content into a video representation advantageously, inter alia, according to date, location and/or user or device information. This way users may for example create lots of images and/or videos on their electronic devices and offer them to be used by the arrangement to create a number of coherent video representations comprising content created by the users on different electronic devices in various locations and instances of time. For example, a number of people participating in an event or happening creating digital content such as digital images and video by e.g. their mobile devices may offer their content to be collected and combined into a video representation of said event or happening, wherein the image and/or video content constituting the video representation are optionally sequentially arranged according to e.g. location or time data information associated with said images and/or videos.

One of the advantageous features of the present invention is that it allows for creating a video representation, particularly a time lapse representation, automatically by taking into account the amount and/or the nature and/or format of the content and combining the content, such as images, with suitable audio according to the amount and/or nature of the images.

In accordance with one aspect of the present invention an electronic arrangement, optionally a number of servers, comprising:
a computing entity configured to receive image entities from a plurality of electronic devices, optionally mobile terminals, and configured to process said image entities, the computing entity being specifically configured to:
   obtain a plurality of image entities from said plurality of electronic devices, and
   combine the obtained image entities into a video representation according to the metadata associated with the image entities, optionally date and/or time data, and/or the source of the image entities.

According to an exemplary embodiment of the present invention the electronic arrangement comprises one or more electronic devices, such as terminal devices, optionally mobile terminal devices or ‘smartphones’, tablet computers, phablet computers, desktop computers or servers. According to an exemplary embodiment of the present invention the devices may be used by different users, optionally essentially separately from each other.

According to an exemplary embodiment of the present invention the electronic arrangement is configured to receive, process and/or combine image entities into a video representation by using positioning or geolocation information, obtained from the electronic devices. Such positioning information may be acquired by the electronic devices by utilizing techniques such as: Global Positioning System (GPS), other satellite navigation systems, Wi-Fi-based positioning system (WPS), hybrid positioning system, and/or other positioning system.

According to an exemplary embodiment of the present invention the computing entity may be configured to arrange the image entities by the location information such that the image entities are sequentially ordered according to the proximities of their capturing device locations, optionally without using the image entity metadata information. Optionally the location information obtained directly from the electronic devices may be used together with the associated image entity metadata, optionally such that either is preferred over the other. For example, the location data obtained from the electronic device may be used to first arrange the image entities sequentially and any metadata information type such as time data or location data provided with the image entities may be used to further on (re)arrange the ordering of said entities. Optionally the computing entity may be configured to add the location information received from the electronic devices to the image entity metadata.

According to an exemplary embodiment of the present invention the positioning information obtained from the electronic devices may be used for the video representation to establish visualization, such as presenting location information in the video representation. The positioning data may be further on used for other purposes i.a. relating to the construction of the video representation.

According to an exemplary embodiment of the present invention the electronic devices may comprise image entities, video entities and/or audio entities. According to an exemplary embodiment of the present invention the devices may be used to create the image entities, such as by taking photographs, recording sound, and/or creating video.

According to an exemplary embodiment of the present invention the image entities of the arrangement may comprise or be at least somehow associated with metadata, which may be embedded to the image entities, such as written to an image entity code, or otherwise added or linked to the image entities, such as an accompanying sidecar file or a tag file. Metadata preferably comprises at least one information type of the following: creation date and/or time, creation location, ownership, what device created the entity, keywords, classifications, size, title and/or copyrights.

According to an exemplary embodiment of the present invention the video representation comprises or consists of at least two or more image entities. According to an exemplary embodiment of the present invention the video representation comprises a number of image entities and a number of video files. According to an exemplary embodiment of the present invention the video representation comprises only a number of video files. According to an exemplary embodiment of the present invention the video representation comprises image entities and a number of audio entities. According to another embodiment of the present invention the video representation comprises image entities, video entities and audio entities.

According to an exemplary embodiment of the present invention the video representation is a time-lapse or other digital video file.

According to an exemplary embodiment of the present invention the video representation may comprise a representation of the selected image entities arranged essentially sequentially. The sequence may be achieved by arranging image entities according to metadata information such as for example time or location data, so that image entities may be in a chronological sequence or in a location-according sequence. The sequence may comprise combining a plurality of metadata information types as basis for achieving certain preferred sequence, optionally such that the metadata information types have different priorities over each other enabling the computing entity to arrange the image entities into a video representation according to the priorities of the metadata information types and the availability of metadata information types. For example, in the absence of a metadata information type the next in priority may be used. Additionally the computing entity may comprise image entities into a video representation only if they have required metadata information such as location information for example for ensuring that the image entities used for video representation are desired.

According to an exemplary embodiment of the present invention the frame rate, the frame frequency or image entity frequency, i.e., the pace at which the sequential image entities are gone through, may be set automatically for example optionally substantially from 5 image entities per second to 6, 8, 10, 12, 14 or 16 image entities per second or to another number of image entities per second. According to an exemplary embodiment of the invention the frame rate is set automatically according to the amount of selected image entities used in the video representation, such as that for example an increase in the amount of image entities used in the video representation increases the frame rate or that increase in the amount of image entities used in the video representation decreases the frame rate. Optionally the frame rate may be set according to a user input.

According to an exemplary embodiment of the present invention the image entities preferably comprise digital image files, such as pictures, drawings, photographs, still images, layered images and/or other graphics files. The digital image files may be vector and/or raster images. According to an exemplary embodiment the image entities used for the video representation consist of essentially single file format. According to an exemplary embodiment the image entities used for the video representation comprise essentially a plurality of different file formats. According to an exemplary embodiment of the present invention an image entity may comprise a plurality of digital image files, such as pictures, drawings, photographs, still images, layered images and/or other graphics files, optionally arranged in a sequence and/or as a video.

According to an exemplary embodiment of the present invention the image entities may be from and/or created by a number of different devices. According to an exemplary embodiment of the present invention a number of the image entities may be created by an electronic device itself either automatically or responsive to user input via a camera feature. According to an exemplary embodiment of the present invention a number of the image entities may have been created outside the electronic devices and utilized by the devices or retrieved on the devices. According to an exemplary embodiment of the present invention the image entities may comprise a combination of image entities produced by the electronic devices and image entities acquired externally, optionally stored on a remote device or transferred to the arrangement from an external source.

According to an exemplary embodiment of the present invention the image entities are stored in the electronic devices. According to an exemplary embodiment of the present invention the image entities are stored in a remote cloud computing entity, such as a remote server, wherefrom they may be accessible and displayable via a plurality of different devices, such as mobile and desktop devices and other servers.

According to an exemplary embodiment of the present invention the video representation may comprise a number of audio entities, such as music, optionally in an even time signature such as 4/4 or 2/4. According to an exemplary embodiment of the present invention the audio entities may be chosen by the computing entity according to the image entities for example according to the amount of selected image entities and/or intended length of the video representation. According to an exemplary embodiment of the present invention the audio used in the video representation may be chosen or be at least suggested by a number of users, optionally by users of the electronic devices. According to an exemplary embodiment of the present invention the audio entities used in the video representation may be added before the video representation is produced and/or after the video representation is produced.

According to an exemplary embodiment of the present invention the audio entities may comprise a number of digital music files or e.g. audio samples constituting optionally multi-channel audio track.

According to an exemplary embodiment of the present invention the audio entities may be comprised in the electronic devices, in a server or in the arrangement's memory entity. Additionally the audio entities may be created by a number of different electronic devices either automatically or responsive to user input via an audio recording feature or a video camera feature.

According to an exemplary embodiment of the present invention additional video entities may also be optionally used. The video entities may be comprised in the electronic devices, in a server or in the arrangement's memory entity. The video entities may be created by a number of different electronic devices either automatically or responsive to user input via a video camera feature.

According to an exemplary embodiment of the present invention the computing entity is preferably used to combine image entities and optionally other entities such as video and audio entities to produce a video representation. Additionally the computing entity may be able to process image entities, video entities and/or audio entities. The processing techniques comprise inter alia format conversion, enhancement, restoration, compression, editing, addition of effects, addition of text or other graphics, addition of filter(s), scaling, layering, change of resolution, orienting, noise reduction, image slicing, sharpening or softening, size alteration, cropping, fitting, inpainting, perspective control, lens correction, digital compositing, changing color depth, changing contrast, adjusting color, warping, brightening, rendering and/or (re)arranging.

According to an exemplary embodiment of the present invention at least a part of image entity, video entity and/or audio entity processing may be done in the electronic devices before being collected by the arrangement.

According to an embodiment of the present invention the electronic devices may control what content such as which image entities they allow (and vice versa what content they won't allow) to be collected and/or utilized by the arrangement.

According to an exemplary embodiment of the present invention the arrangement comprises allocating the computing entity tasks, such as collecting, processing and/or combining the image entities and other optional entities into a video representation, to a plurality of electronic devices for example for carrying out the method phases parallel for different parts of content.

In accordance with one aspect of the present invention a method for creating a video representation through an electronic arrangement, comprising:
obtaining a plurality of image entities from a plurality of electronic devices, and
combining the obtained image entities into a video representation according to the metadata associated with the image entities, optionally date and/or time data, and/or the source of the image entities.

According to an exemplary embodiment of the present invention the image entities and other optional entities are combined as a video representation sequentially according to their metadata. The metadata may comprise many types of information as also presented hereinbefore and the various information types may be categorized and/or prioritized. The different sequences of the video representation may optionally be achieved according to said metadata information type priorities.

In accordance with one aspect of the present invention a computer program product embodied in a non-transitory computer readable medium, comprising computer code for causing the computer to execute:
obtaining a plurality of image entities from a plurality of electronic devices, and
combining the obtained image entities into a video representation according to the metadata associated with the image entities, optionally date and/or time data, and/or the source of the image entities.

According to an embodiment of the present invention the computer program product may be offered as a software as a service (SaaS).

Different considerations concerning the various embodiments of the electronic arrangement may be flexibly applied to the embodiments of the method mutatis mutandis and vice versa, as being appreciated by a skilled person.

As briefly reviewed hereinbefore, the utility of the different aspects of the present invention arises from a plurality of issues depending on each particular embodiment.

The expression “a number of” may herein refer to any positive integer starting from one (1). The expression “a plurality of” may refer to any positive integer starting from two (2), respectively.

The term “exemplary” refers herein to an example or an example-like feature, not to the sole or only preferable option.

Different embodiments of the present invention are also disclosed in the attached dependent claims.

### BRIEF DESCRIPTION OF THE RELATED DRAWINGS

Next, the embodiments of the present invention are more closely reviewed with reference to the attached drawings, wherein

FIG. 1 illustrates an embodiment of the arrangement in accordance with the present invention.

FIG. 2 is a flow diagram of one embodiment of the method for creating a video representation through an electronic arrangement in accordance with the present invention.

FIG. 3 illustrates an embodiment of a video representation of said image entities in accordance with the present invention.

### DETAILED DESCRIPTION OF THE EMBODIMENTS

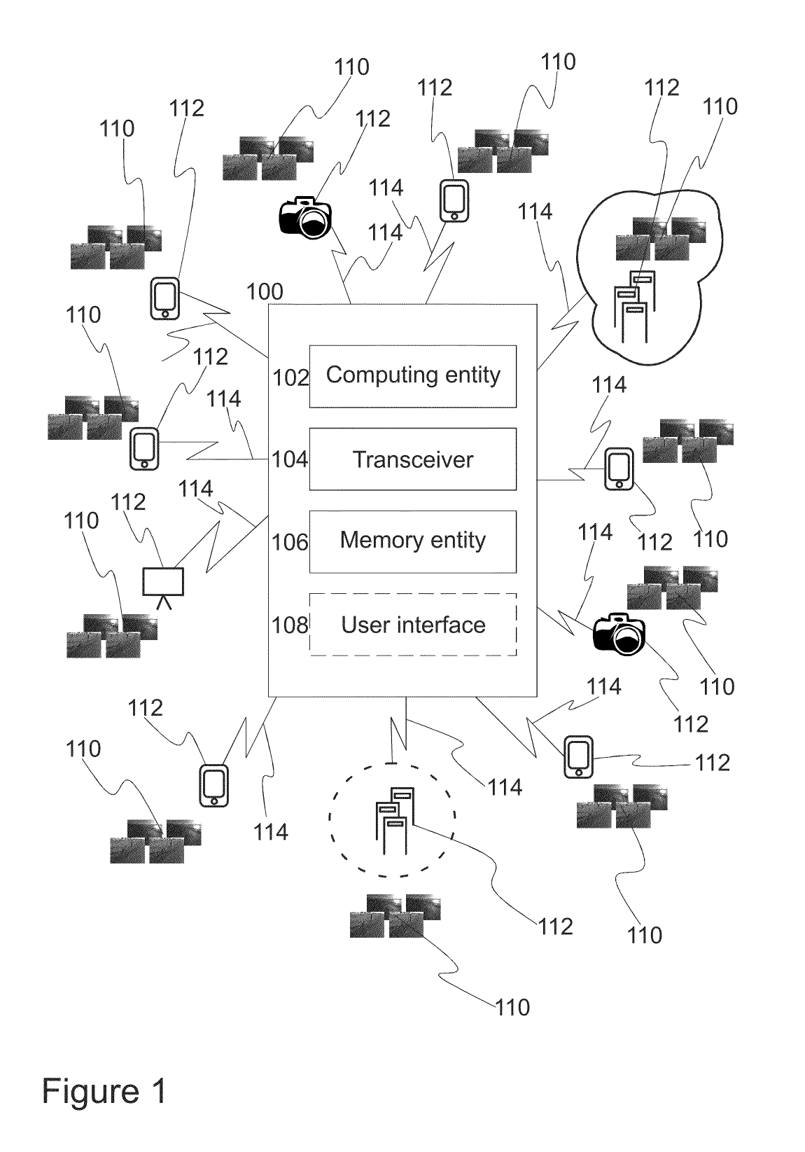

With reference to FIG. 1, an embodiment of the electronic arrangement 100 of the present invention is illustrated.

The electronic arrangement 100 essentially comprises a computing entity 102, a transceiver 104, a memory entity 106 and a user interface 108. The electronic arrangement 100 is further on configure to receive and/or collect image entities 110 from electronic devices 112 via communications networks and/or connections 114. Further on, the arrangement 100 may be configured to receive also other content, such as audio and/or video entities from the electronic devices 112 via the communications networks and/or connections 114.

The electronic arrangement 100 may comprise or constitute a number of terminal devices, optionally mobile terminal devices or ‘smartphones’, tablet computers, phablets, desktop computers, and/or server entities such as servers in a cloud or other remote servers. The arrangement 100 may comprise any of the electronic devices 112 comprising and/or creating/capturing image entities 110, or a separate device, optionally essentially autonomically or automatically functioning device such as a remote server entity.

The computing entity 102 is configured to at least receive image entities 110, process image entities 110, store image entities 110 and combine image entities 110 into a video representation, optionally with other content such as audio entities and/or video entities. The computing entity 102 comprises, e.g. at least one processing/controlling unit such as a microprocessor, a digital signal processor (DSP), a digital signal controller (DSC), a micro-controller or programmable logic chip(s), optionally comprising a plurality of co-operating or parallel (sub-)units.

The computing entity 102 is further on connected or integrated with a memory entity 106, which may be divided between one or more physical memory chips and/or cards. The memory entity 106 is used to store image entities 110 and other content used to create a video representation as well as optionally the video representation itself. The memory entity 106 may further on comprise necessary code, e.g. in a form of a computer program/application, for enabling the control and operation of the arrangement 100 and the user interface 108 of the arrangement 100, and provision of the related control data. The memory entity 106 may comprise e.g. ROM (read only memory) or RAM-type (random access memory) implementations as disk storage or flash storage. The memory entity 106 may further comprise an advantageously detachable memory card/stick, a floppy disc, an optical disc, such as a CD-ROM, or a fixed/removable hard drive.

The transceiver 104 is used at least to collect image entities 110 from the electronic devices 112 and other devices. The transceiver 104 preferably comprises a transmitter entity and a receiver entity, either as integrated or as separate essentially interconnected entities. Optionally, the arrangement 100 comprises at least a receiver entity. The transceiver 104 connects the arrangement 100 with the devices 112 with preferably duplex communication connections 114 via a telecommunications network, such as wide area network (WAN) and/or local area network (LAN).

The user interface 108 is device-dependent and as such may embody a graphical user interface (GUI), such as those of mobile devices or desktop devices, or command-line interface e.g. in case of servers. The user interface 108 may be used to give commands and control the software program. The user interface 108 may be configured to visualize, or present as textual, different data elements, status information, control features, user instructions, user input indicators, etc. to the user via for example a display screen. Additionally, the user interface 108 may be used to control the arrangement 100 such that for example user control in initiating functions such as the action to create, collect and/or process image entities 110 and/or to create a video representation of image entities 110. This allows for e.g. user involvement in choosing content, arranging content, determining metadata priorities and/or which metadata is used, editing any content including the video representation, and/or sharing content with other devices.

The image entities 110 preferably comprise digital image files, such as pictures, drawings, photographs, still images, layered images and/or other graphics files. The digital image files may be vector and/or raster images. An image entity 110 may optionally additionally comprise a plurality of the abovementioned graphics files, optionally arranged as video or otherwise sequentially.

The image entities 110 may be stored in the arrangement's 100 memory entity 106, in the electronic devices 112 or in a number of other devices such as remote servers (not otherwise used to create image entities 110), wherefrom the image entities 110 may be accessible and displayable via the electronic devices 112 and the arrangement 100.

The image entities 110 may be originally from and/or created by a number of different devices, such as from the various different electronic devices 112. An image entity 110 may be created by an electronic device 112 itself either automatically or responsive to user input via a camera, image creating and/or image editing/processing feature. A number of the image entities 110 may have been created outside the electronic devices 112 and utilized by the arrangement 100 or retrieved on the arrangement 100 to be used by the arrangement 100 to create the video representation, for instance. The image entities 110 may also comprise a combination of image entities 110 produced by the electronic devices 112 and image entities 110 acquired externally, optionally stored on a remote device or transferred to the arrangement 100 from an external source.

The image entities 110 may comprise a number of file formats. The computing entity 102 may be configured to convert file formats so that they are suitable to be processed and combined into a video representation.

The image entities 110 comprise also metadata, which metadata is used for creating the video representation. The metadata may be embedded to the image entities 110, such as written to an image entity 110 code, or otherwise added to the image entities 110, such as an accompanying sidecar file or a tag file. Metadata preferably comprises at least one information type of the following: creation date and/or time, creation location, ownership, what device created the entity, keywords, classifications, size, title and/or copyrights.

Additionally metadata may be comprised and/or created according to a standard type such as exchangeable image file format (Exif). Other forms include Dublin Core Schema, International Press Telecommunications Council Information Interchange Model (IPTC-IIM), IPTC Core, IPTCT Extension, Extensible Metadata Platform (XMP) and Picture Licensing Universal System (PLUS).

The arrangement 100 may be configured to receive, in addition to or instead of image entity 110 metadata-based location data, positioning data from the electronic devices 112, which data may be used to arrange the image entities 110 into a video representation. Such positioning data may be acquired by the electronic devices 112 by utilizing techniques such as: GPS, other satellite navigation systems, WPS, hybrid positioning system, and/or other positioning system.

The arrangement 100 may receive, store and/or utilize other content such as video entities and/or audio entities. Said entities may be acquired from the electronic devices 112. The video and audio entities may also comprise metadata similar to the image entities 110.

The invention may be embodied as a software program product that may incorporate one or more electronic devices 112. The software program product may be as SaaS. The software program product may also incorporate allocating processing of image entities 110, video entities and/or audio entities to one or more devices 112, optionally simultaneously. The software program product may also incorporate allocating and dividing computing tasks related to i.a. creating the video representation to one or more devices 112. Optionally the invention may be facilitated via a browser or similar software wherein the software program product is external to the arrangement 100 but remotely accessible and usable together with a user interface 108. The software program product may include and/or be comprised e.g. in a cloud server or a remote terminal or server.

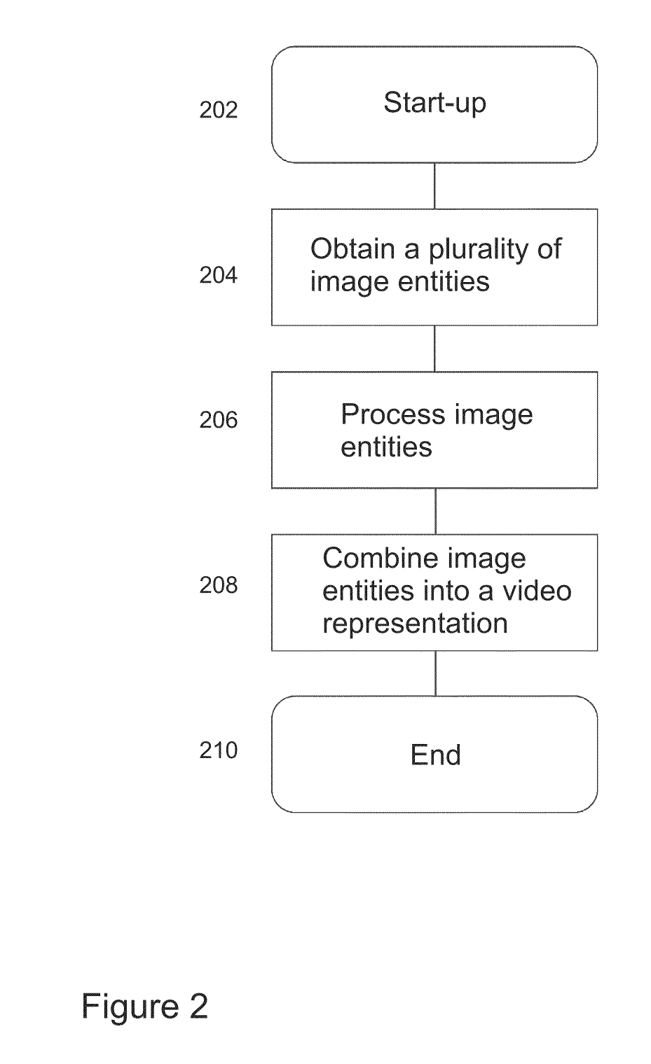

With reference to FIG. 2, flow diagram of one embodiment of a method for creating a video representation through an electronic arrangement in accordance with the present invention is shown.

At 202, referred to as the start-up phase, the arrangement executing the method is at its initial state. At this initial phase the computing entity is ready to detect and act on user input via the graphical user interface. Optionally the metadata settings, such as which metadata information types are preferred and/or priorities among the different metadata information types, and/or utilization of electronic device positioning data may be determined.

At 204, image entities are obtained from one or more electronic devices. Additionally content such as video and audio entities may be also obtained from the electronic devices, a database on a remote server and/or from the arrangement's own memory entity.

Additionally, the users of the electronic devices may control what they wish to share, i.e., what content they allow to be collected for the video representation.

Some image entities may be already combined in the devices at this phase, optionally as video. For example, image entities created substantially sequentially in a burst mode, or otherwise so that any of their metadata information types are close to each other, such as locations substantially close to each other, may be combined as video already in the electronic device before being obtained by the arrangement.

Additionally, positioning data from a number of electronic devices may be acquired at this phase, optionally together with the image and/or other entities. Said positioning data may be used to essentially instantaneously combine the image and/or other entities together. Optionally the positioning data may be used to categorize or otherwise associate the image entities, optionally according to the electronic device proximities to each other for example such that the closer the image and/or other entities capturing electronic devices are to each other, and/or to the arrangement, the closer said image and/or other entities are associated together e.g. in the video representation sequences. The electronic device locations and/or mutual proximities/distances of each other are preferably measured at the time the content is created allowing the arrangement or the electronic device capturing the content to associate the positioning information with the image entities, optionally as metadata or as separate data sent from the electronic device to the arrangement.

At 206, the image entities and other optional entities are processed. Such processing may comprise inter alia format conversion, enhancement, restoration, compression, editing, addition of effects, addition of text or other graphics, addition of filter(s), scaling, layering, change of resolution, orienting, noise reduction, image slicing, sharpening or softening, size alteration, cropping, fitting, inpainting, perspective control, lens correction, digital compositing, changing color depth, changing contrast, adjusting color, warping, brightening, rendering and/or (re)arranging.

Optionally additionally the file formats are converted so that they are mutually compatible and/or so that they can be used to produce the video representation, optionally such that the entity formats support and are translatable into the video representation file format.

One aspect of carrying out the processing is also to make the image entity transitions more fluent inside the video representation, optionally by harmonizing the image entities at least in reference to one or more of the preceding and succeeding image entities of any image entity in a sequence. The device configuration related image parameters such as focal length, exposure, resolution, colors, etc. may lead to very different looking images. To avoid hard-to-follow and out-of focus video representations the processing may substantially unify said parameters so that the sequential image entities constitute a more coherent set. Using different filter for example may be used to adjust colors and brightness and to sharpen images, etc.

Optionally additionally at least part of the image entity, video entity and/or audio entity processing may be done in the electronic devices before being collected by the arrangement.

At 208, the image and other optional entities are combined into a video representation, optionally sequentially according to their metadata, and/or at least partly to the positioning data. The action to combine image and other optional entities into a video representation may be initiated substantially automatically optionally directly after the computing entity has obtained a selection of image entities and processed said image entities, and/or according to a user input. The selection of images may be determined by having a preset to collect a number of image entities and/or other optional entities, the preset being optionally predetermined and changeable. The selection may be also dynamic so that it takes into account the essentially available image and/or other optional entities in the electronic devices, such that the selection is created of the image and/or other optional entities that the arrangement is able to collect and use according to metadata parameters. Additionally optionally only the image and/or other optional entities with suitable metadata may be used.

The sequential order may be for example chronological or location-based. Further on, any metadata information may be used to either construct the sequences of the content constituting the video representation or to visualize or otherwise add content to the representation. For example, any data type may be visualized as optionally textually about the location, user, device, time and/or device of the content on the graphical video representation.

Optionally additionally a user may be asked to confirm that the image and other optional entities are combined into a video representation essentially before the video representation is created. The confirmation may also comprise adding or removing image and other optional entities that are used for the video representation, processing said entities, and/or presenting a user with a preview of the video representation according to the image entity and other optional entity selection. Optionally user may change the metadata and/or other positioning data preferences constituting the sequence of the video representation, for example (re)arranging the content chronologically or location-wise.

The user may be also inquired of whether audio entities are added to the video representation and/or what kind of audio entities are used. Optionally a number of audio entities may be added to the video automatically, such as image entities received by the arrangement after the video representation has been created.

At 212, referred to as the end phase of the method, the user may be presented with the video representation and/or the video representation may be transferred or saved to a location, optionally according to user input. The video representation may be further on processed and edited. Optionally the video representation may be sent to the users' electronic devices.

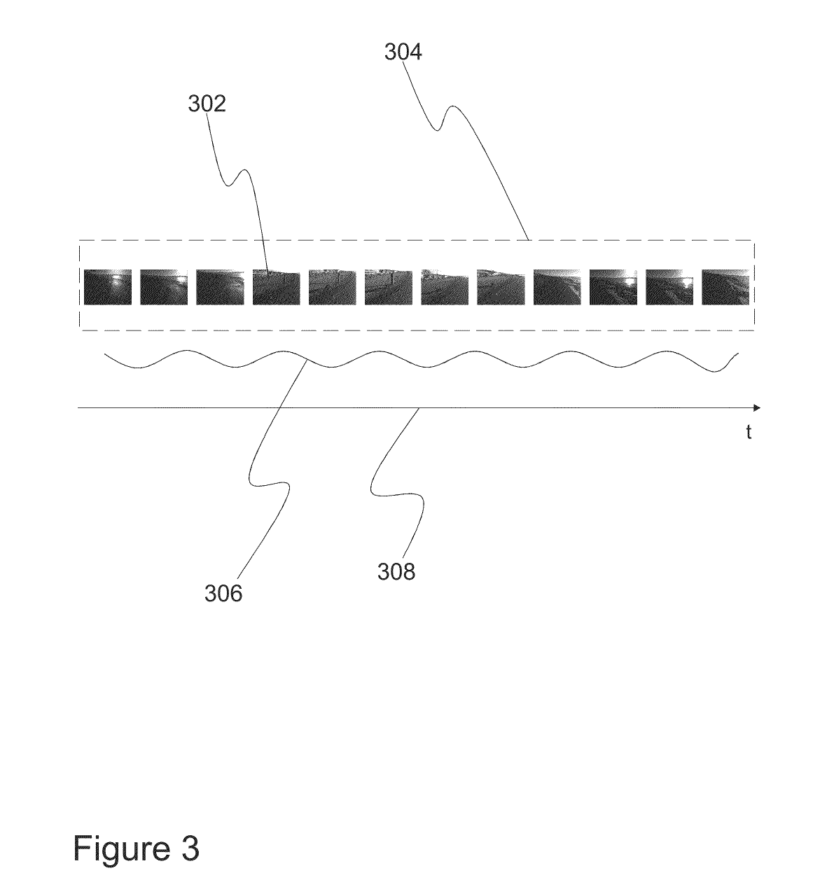

With reference to FIG. 3, a video representation 304 comprising a number of image entities 302 and an audio entity 306 is presented.

The video representation 304 comprises preferably at least two or more image entities 302 (the only one pointed out as an example of one of the many image entities 302) arranged essentially sequentially according to their metadata, for example chronologically according to time/date information (as illustrated with the time axle 308) comprised in the image entities 302. Optionally the image entities 302 may be arranged essentially sequentially according to any other metadata information type, such as according to location information. The arrangement may utilize the positioning information of the electronic devices essentially at the time the image entities 302 are created, optionally together with the metadata.

The metadata information comprises different types of information, such as creation date and/or time, creation location, ownership, what or what type of device created the entity, keywords, classifications, size, title and/or copyrights of the content, which information types may have different priorities in relation to each other such that for example the image entities 302 are essentially preferably and/or primarily arranged chronologically or according to location data. In the absence of a preferred metadata information type the next metadata information type in priority is used for arranging the content. The metadata information type priorities may have presets and/or they may be set and/or changed according to user preferences, optionally before and/or after the image entities 302 and other optional entities are combined into a video representation 304.

Additionally any metadata information type and/or the electronic device positioning data may be used, in addition to constituting the sequential structure of the video representation 304, to visualize graphically and/or textually information, optionally about the event, happening, location, time and/or date, and/or user essentially on the video representation 304.

Additionally, the video representation 304 may comprise only image entities 302, a combination of image entities 302 and audio entities 306, a combination of image entities 302, audio entities 306 and video entities, only video entities, and/or video entities and audio entities 306. The video representation 304 may comprise a time-lapse or other digital video.

The optional video entities may comprise a number of digital video files. The video entities may be created by a number of different electronic devices either automatically or responsive to user input via a video camera feature. Optionally additionally the video entities may be created by the electronic devices by combining a plurality of image entities 302. The video entities may be comprised in the electronic devices, in a server or in the arrangement's memory entity.

The video representation 304 may comprise, in addition to the image entities 302, audio entities 306 and/or video entities obtained from the electronic devices, other image entities 302 such as blank, different colored images and/or predetermined images in between, before and/or after said image entities 302 and/or video entities. Said other image entities 302 may be chosen by a user and/or they may be added to the video representation 304 automatically according to predefined logic.

The frame rate of the video representation 304 may be set optionally automatically, for example, optionally substantially to 5 frames per second or to 6, 8, 10, 12 or 14 frames per second or to more image entities 302 per second or to less image entities 302 per second. Optionally, the frame rate may be set automatically according to the number of selected image entities 302 and/or video entities used in the video representation 304, such as that for example an increase in the amount of image entities 302 used in the video representation 304 increases the frame rate or that increase in the amount of image entities 302 used in the video representation 304 decreases the frame rate. Optionally, the frame rate may be set according to a user input. Optionally additionally the frame rate may be set according to the audio entities 306 for example according to the nature of the audio entities 306 i.e., the type or time signature of the audio content.

The video representation 304 as well as the other optional video entities are preferably in a digital format, the format being optionally chosen by a user.

The audio entities 306 may comprise a number of digital music files or e.g. audio samples constituting optionally multi-channel audio track. The audio entity 306 is preferably music in an even time signature such as 4/4 or 2/4. Alternatively or additionally, the audio entity 306 may include ambient sounds or noises. The audio entities 306 comprised in the video representation 304 may be chosen by a user or the audio entity 306 may be optionally chosen by the computing entity for example according to the amount of selected image entities 302 and/or length of the video representation 304, and/or according to a predetermined choices of audio entities 306, such as from a list of audio files, optionally as a “playlist”. The audio entity 306 comprised in the video representation 304 may be added before the video representation 304 is produced and/or after the video representation 304 is produced.

The audio entities 306 may be comprised in the electronic devices, in a server or in the arrangement's memory entity. Additionally the audio entities 306 may be created by a number of different electronic devices either automatically or responsive to user input via an audio recording feature or a video camera feature.

Selecting adequate audio entities 306 for the video representation 304 comprises at least leaving out the most complex and/or rhythmically complex pieces as they result in a much less cohesive and complex outcome and aren't suitable with a fixed frame rate. Suitable audio entities 306 that lead to a more seamless video representation 304 comprise music in a simple time signature with less harmonic complexity and irregularity in accentuation.

The scope of the invention is determined by the attached claims together with the equivalents thereof. The skilled persons will again appreciate the fact that the disclosed embodiments were constructed for illustrative purposes only, and the innovative fulcrum reviewed herein will cover further embodiments, embodiment combinations, variations and equivalents that better suit each particular use case of the invention.

1. An electronic arrangement, optionally a number of servers, comprising:
a computing entity configured to receive image entities from a plurality of electronic devices, optionally mobile terminals, and configured to process said image entities, the computing entity being specifically configured to:
obtain a plurality of image entities from said plurality of electronic devices, and
combine the obtained image entities into a video representation according to the metadata associated with the image entities, optionally date and/or time data, and/or the source of the image entities.

2. The arrangement according to claim 1, wherein a number of audio entities are combined with the image entities to create a video representation.

3. The arrangement according to claim 1, wherein the metadata comprises at least one information type of the following: creation date and/or time, creation location, ownership, what or what type of device created the entity, keywords, classifications, size, title and/or copyrights.

4. The arrangement according to claim 1, wherein location data associated with image entities, optionally as metadata, may be used to at least partly establish the video representation, optionally to determine the mutual order of image entities in the video representation.

5. The arrangement according to claim 1, wherein the video representation comprises a video file incorporating said image entities sequentially ordered.

6. The arrangement according to claim 1, wherein the frame rate of the video representation is substantially about 5 frames per sec or 8, 10, 12, 14 frames per second.

7. The arrangement according to claim 1, wherein the computing entity is a remote server, such as one or more servers in a cloud.

8. The arrangement according to claim 1, wherein the computing entity is one of the electronic devices.

9. The arrangement according to claim 1, wherein the computing entity's processing of image entities comprises at least one from the list of: format conversion, enhancement, restoration, compression, editing, addition of effects, addition of text or other graphics, addition of filter(s), scaling, layering, change of resolution, orienting, noise reduction, image slicing, sharpening or softening, size alteration, cropping, fitting, inpainting, perspective control, lens correction, digital compositing, changing color depth, changing contrast, adjusting color, warping, brightening, rendering and/or (re)arranging.

10. The arrangement according to claim 1, wherein the video representation of said image entities is a digital video file.

11. The arrangement according to claim 1, wherein the video representation of said image entities is a time-lapse.

12. The arrangement according to claim 1, wherein the image entities comprise digital image files, such as vector or raster format pictures, photographs, layered images, still image and/or other graphics files.

13. The arrangement according to claim 1, wherein an image entity comprises a number of digital image files, still images, photographs, and/or other graphics files, optionally as video.

14. The arrangement according to claim 1, wherein the audio entity comprises a number of digital music files or e.g. audio samples constituting optionally multi-channel audio track.

15. The arrangement according to claim 1, wherein the electronic devices comprise one or more mobile terminals, optionally smartphones.

16. The arrangement according to claim 1, wherein the electronic devices comprise one or more tablets and/or phablets.

17. The arrangement according to claim 1, wherein the electronic devices comprise one or more desktop computers, laptop computers, or digital cameras, optionally add-on, time-lapse, compact, DSLR or high-definition personal cameras.

18. The arrangement according to claim 1, wherein the electronic devices preprocess image entities before the computing entity collects the image entities.

19. A method for creating a video representation through an electronic arrangement, comprising:
obtaining a plurality of image entities from a plurality of electronic devices, and
combining the obtained image entities into a video representation according to the metadata associated with the image entities, optionally date and/or time data, and/or the source of the image entities.

20. A computer program product embodied in a non-transitory computer readable medium, comprising computer code for causing the computer to execute:
obtaining a plurality of image entities from a plurality of electronic devices, and
combining the obtained image entities into a video representation according to the metadata associated with the image entities, optionally date and/or time data, and/or the source of the image entities.
